(19) United States
(12) Patent Application Publication
(10) Pub. No.: US 2016/0104351 A1
(43) Pub. Date: Apr. 14, 2016

(54) DRAG RACING LOTTERY GAME

(71) Applicant: Intralot S.A. Integrated Lottery Systems and Services, Athens (GR)

(72) Inventors: Ioannis Gangas, Athens (GR); Panagiotis Pournaras, Athens (GR); Hector Scoursis, Athens (GR)

(73) Assignee: Intralot S.A. Integrated Lottery Systems and Services, Athens (GR)

(21) Appl. No.: 14/878,069

(22) Filed: Oct. 8, 2015

Related U.S. Application Data
(60) Provisional application No. 62/061,790, filed on Oct. 9, 2014.

(51) Int. Cl. G07F 17/32

(52) U.S. Cl. CPC G07F 17/3267; G07F 17/3269; G07F 17/3288

(57) ABSTRACT

A high frequency betting game, based on 2-runner drag races such as cars, motorcycles, boats and in general any 2-runner (binary result) racing event is disclosed. Players try to predict the result of as many races as possible with a minimum number of races. If players predict correctly the minimum number of races, they are offered a “Dare” or “Variable Dare” challenge to predict consecutive races, one more race each time, to increase their potential winnings with the risk that if a player does not correctly predict a race, they lose their entire bet or a portion of their bet.

This claims the benefit of US Provisional Patent Application Ser. No. 62/061,790, filed Oct. 9, 2014 and hereby incorporated by reference in its entirety.

### BACKGROUND OF THE INVENTION

Lottery games, and especially instant win lottery gaming tickets also known as scratch off lottery tickets, have had a resurgence in popularity in recent years. Their popularity stems from the instant gratification they provide to players. Players instantly know whether they have won or not and there is no need to wait for results as in weekly or bi-weekly lotteries. Also, instant lottery games require more active involvement from the player than the weekly lotteries. Thus, instant lottery games provide more entertainment value to players than other, more regular lotteries. Some lottery customers do not want to wait for a weekly or daily drawing. These customers may purchase “instant-win” lottery tickets. Such tickets may also involve games, such as lotto, battleship, bingo, or other games that increase customer interest and enjoyment in the purchase of such tickets.

Instant-win games differ from pooled drawing games, where a lottery ticket represents a chance in a drawing to be held at some later time for a pooled prize or prizes. Rather, in an instant-win game, whether the ticket is a winner is determined at or before the time the ticket is purchased, although whether the ticket is actually a winner may be concealed from the buyer and seller. Instant-win games may include “extended play” features such as games printed on the ticket, e.g., bingo or number matching. These features may increase the enjoyment and interest level of purchasers of such tickets, causing them to buy tickets in greater numbers or more frequently.

Lotteries are continuously seeking interesting and exciting platforms for new and interesting games. One method of providing entertainment to instant lottery game players is by having instant lottery games attempt to replicate the thrill of familiar events such as sporting events including racing and other competitions.

From the above, it is evident that there is therefore a need for a lottery gaming system or an instant win gaming ticket that provides the required excitement. It should be noted that instant lottery games are a subset of instant win gaming tickets. Such instant win gaming tickets encompass all types of gaming that involve pre-printed tickets that players play by revealing the pre-printed results. As noted above, one possible type of such tickets are those commonly known as “scratch-off” or “scratch and win” lottery tickets.

### SUMMARY OF THE INVENTION

This invention in various embodiments is a new high frequency betting or lottery game, based on pre-recorded 2-outcome, binary event, such as a two-runner drag race with cars, motorcycles or boats, for example. General any two-runner (binary result) event can be employed with this invention and the title of this invention refers to an examplary embodiment and should not be a limitation on the invention.

In various embodiments of this invention, players try to predict the result of as many races as possible, however with a minimum number of races (e.g. 3).

If players predict correctly the minimum number of races they are offered a “Dare” or “Variable Dare” challenge to predict consecutive races, one more race each time, to maximize their potential winnings with the risk that if a player does not correctly predict a dare race, they lose some or all of their entire winnings.

This invention is designed with a variety of different versions and configurations to support a wide range of retail networks (i.e., retail and internet/mobile) and to adapt to various gaming regulations (i.e., betting, lottery, video lottery terminal (VLT), fixed odds betting terminal (FOBT), amusement with payout (AWP), virtual games, e-instant gaming, etc.).

This invention may be implemented in its fixed-odds form, but the invention is also possible to be played as a pari-mutual game where pools are created for selected bet types. In one exemplary embodiment disclosed herein, this invention may be employed in a drag racing context. However, it will be appreciated by one of ordinary skill in the art that the invention may be employed in many other contexts, such as any other two outcome event (boxing, fencing, wrestling, etc.) or binary event (coin flip, etc.). The event may be a live, pre-recorded or virtual (3D animation) and within a lottery, but also a betting, VLT, AWP, FOBT, instant win or other format.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings in which:

FIG. 1 is an exemplary introductory view of one embodiment of this invention;

FIG. 2 is an exemplary view of the odds of winning according to the number in which a player participates in the embodiment of FIG. 1;

FIG. 3 is an exemplary view of a six race player selection screen of FIG. 2;

FIG. 4 is an exemplary countdown timer after the player has made the requisite selections in FIG. 3;

FIG. 5 is an exemplary view of a sixth race screen according to the embodiment of FIGS. 1-4;

FIG. 6 is an exemplary embodiment showing the race results for FIGS. 1-5 and providing an opportunity for continued play or game termination;

FIG. 7 is an exemplary view of a screen for continued game play via a “Dare” option;

FIG. 8 is an exemplary view of a screen showing play options for a selected “Dare” game play;

FIG. 9 is an exemplary view of the odds of winning according to the game play from FIG. 8;

FIG. 10 is an exemplary screen showing a game result; and

FIG. 11 is an exemplary screen showing the player's race results.

### DETAILED DESCRIPTION OF THE INVENTION

This invention may be embodied in a variety of game play styles and versions, including an on-demand version and a broadcast version as described below.

In an on-demand version of game play according to this invention, events are triggered by the player with an individual (local) or with a centrally provided random number generated (RNG) draw (server based). Players may use self-service terminals, the internet, mobile phones or tablets on which they are able themselves to initiate a racing event or game sequence. Pre-recorded videos of the race or game sequences may be either locally stored or centrally streamed on demand in response to a player's request.

In a broadcast version of game play according to this invention, events are based on a pre-defined daily schedule (such as a 24/7 service) and utilize a centrally provided RNG draw which is identical for all players on any specific race. This version can be embodied in at least two formats: broadcast interactive or broadcase passive.

A broadcast interactive version may be played on self-service terminals and internet/mobile device interactively, but according to a central events schedule. The pre-recorded videos of the race or game events may be centrally broadcast to each device according to the predefined time schedule via satellite or internet protocol (IP) delivery means.

A broadcast passive version may be played via agent terminals through special coupons and/or verbal play according to a central events schedule. Events may be broadcasted to point of sale (POS) monitors via satellite or IP delivery means.

The specific video to be broadcast for each game or race event can either be based on RNG draw of the result or an RNG draw of the race. For an RNG drawn result, the RNG determines the outcome. For example, the RNG draws “outcome 2” (from 1 or 2) and the system searches an available video from the video library where a 2 result is drawn. For race drawn result, the RNG draws a race from a library of races where the results are equally distributed (i.e. there are 500 videos representing result 1 and 500 videos representing result 2) in order to guarantee the trueness of the 50/50 probabilities of an outcome for each game or race event.

In an on-demand version of this invention, players are shown the odds for the minimum number of succesfull predictions they must achive and the subsequent odds for a number of “Dare” sequences offered. The number of minimum races is set according to the commercial model (payout, etc.) of each lottery operator. The minimum number of races may range from 3-5. Odds increase according to the number of correct predictions. The player is shown the potential winnings based on their stake. For example, a $5 bet can win $650 if the player predicts 10 races correctly. Players are also informed at this stage of the maximum allowed events they are allowed to bet on.

TABLE 1
Indicative Odds/Winnings for On-Demand Version

| | | | | | Each Next | |
|---|---|---|---|---|---|---|
| Min. | | | 1^{st} Dare | 2^{nd} Dare | Dare | |
| Races | Odds | Payout | On Stake | On Stake | On Winnings | Jackpots |
| 3 | 6 | 75.00% | 11 | 20 | x2 | Yes |
| 3 | 7 | 87.50% | 13 | 25 | x2 | Yes |
| 4 | 11 | 68.75% | 20 | 40 | x2 | Yes |
| 4 | 12 | 75.00% | 22 | 40 | x2 | Yes |
| 4 | 13 | 81.25% | 24 | 45 | x2 | Yes |
| 4 | 14 | 87.50% | 26 | 50 | x2 | Yes |
| 4 | 15 | 93.75% | 28 | 55 | x2 | Yes |

Table 1 is a representative odds chart which is fully customizable according to payout/market requirements of each market or lottery operator (i.e. minimum number of races or events, jackpots, maximum winnings, maximum events allowed, coefficients per minimum or “Dare” etc.). These factors may be changed according to commercial targets set by each lottery operator.

An exemplary game sequence according to one embodiment of this invention will now be discussed. A player engages a play device to initiate a racing event and/or game sequence. As noted above, the play device may include but is not limited to a self-service terminal, a mobile phone, a smart phone, a tablet, a computing device located remote to a gaming facility, a computing device located at a gaming facility, and/or any other type of play device that is capable of broadcasting the racing event as the racing event is streamed to the player as well as transmitting betting requests as would be appreciated by one of ordinary skill in the art.

For example, the player first selects via the play device to place a bet on four races placing a stake of $10, with an odds at ×13 the betting unit. The play device then displays a countdown timer that appears showing the available remaining betting selections time. If players do not engage the play device to make a selection on time for the next required race, they may be given one more and final chance of extending their decision period by 10 seconds. If this chance is used once, all the upcoming betting decisions should be made on time, otherwise the bet is lost.

After the bet has been placed, a racing lottery game computing device receives the bet information and initiates a random selection process of various races previously recorded and stored by the lottery computing device. In doing so, the racing lottery game computing device randomly selects the outcome of the race from a first outcome or a second outcome. Based on the random selection of the first outcome or the second outcome, the racing lottery computing device then searches all available video feeds that are stored in a racing lottery computing server that have the selected outcome. For example, the racing lottery computing device first selects the first outcome and then searches all available video feeds stored in the racing lottery computing server that result in the first outcome. The racing lottery computing device then randomly selects a race from the races that have the first outcome.

The race selected by the racing lottery computing device with the selected outcome is then applied to the player's bet. The racing lottery computing device then streams the selected race to the play device in which the play device then broadcasts the selected race to the player. After each race is broadcast, the racing lottery computing device may stream a slow-motion replay or freeze-frame of the race to the play device that is displayed to the player by the play device so that the result may follow for 2-3 seconds so that the result is clearly verified by the player.

The racing lottery computing device then determines whether the player has successfully predicted the outcomes of the broadcasted race. For example, if all four predictions of the player are successful, the resulting winnings are ($10×13)=$130. A message then informs the player that $130 has been won and an option of cashing-out (collect winnings) or opting for a “Dare” (one more prediction) becomes available. The selection of “Dare” offers the player the chance of winning $240 (stake $10× odds at 24 times the betting unit).

If the player's Dare prediction is again successful, a new message informs them of their $240 winnings and offers another chance for another “Dare” producing an opportunity for winnings of $450 (stake $10× odds at 45 times the betting unit). The process is repeated until the player decides to cashout (stop betting and collect winnings), loses, or the system informs player that he reached the maximum allowed events he can play.

In various embodiments of this invention, a “Variable Dare” option may be available to the player. For example, the Variable Dare may be offered to players who have already achieved the minimum required successful predictions. The Variable Dare option in one embodiment allows betting on an additional event or race, but on a reduced share of the full odds offered (i.e., fractional odds) without risking their entire winnings. Upon successfully predicting the next event or race, the player collects winnings according to the selected “Dare” amount or size, hence the “variable” aspect of this option. If the player is not successful with the event or race prediction, they can still collect their share of their previous winnings equivalent with their Dare size.

For example, if a player has already secured $10 in winnings from a 10× on their original stake of $1.00, a 50% Variable Dare of the next coefficient is selected so instead of a 20× wager, the wager is 15×. If the player is successful on this Variable Dare wager, the winnings are $15 (i.e., 50% of their full coefficient) and if they lose, they still collect $5 (i.e., 50% of their previous winnings). The game may also offer a jackpot functionality whereby a percentage of the player's bet is allocated to a jackpot pool. The jackpot pool may be configurable to be drawn to players betting on both the minimum and the following “Dare” races, if any. A “Mega Jackpot” also may be allocated to players reaching the maximum number of allowed events.

In a broadcast version, a race may be broadcast to TV screens in the POS, self-service terminals or internet/mobile devices at a regular interval such as every one minute. Players may predict the results of a sequence of races, for example from three (minimum) to ten (maximum) starting from the next available race either through special coupons, verbal play and/or on self-service terminals and internet/mobile interactively, but the play is according to a central events schedule. The pre-recorded videos are centrally broadcast to each device according to the predefined time schedule via satellite or IP delivery means.

Each race is referenced by a unique ID number, for example from 1-1440 or one minute of each 24 hour period. Odds are offered for a variable length of betting lines according to a predefined chart, an example of which is shown in Table 2.

TABLE 2
Indicative Odds/Winnings for Broadcast Version

| | Odds | Odds | |
|---|---|---|---|
| Races | (pay out 75%) | (pay out 87.5%) | Jackpots |
| 3 | 6 | 7 | Yes |
| 4 | 12 | 14 | Yes |
| 5 | 24 | 28 | Yes |
| 6 | 48 | 56 | Yes |
| 7 | 96 | 112 | Yes |
| 8 | 192 | 224 | Yes |
| 9 | 384 | 448 | Yes |
| 10 | 768 | 896 | Yes |

The above odds chart of Table 2 is fully customizable according to payout/market requirements of each market or lottery operator (i.e. minimum number of races, jackpots, maximum winnings, maximum events allowed, coefficients per minimum or “Dare”, etc.). These game factors may be changed according to commercial targets set by each operator. Players may make all their betting selections, while a reverse time counter is always displayed between races. Players may either mark their betting selections and once their bet is placed they participate in the next available race or they are able to specify in advance which races they wish to participate in, for example races 400, 500, 634, 1000, 1400 and so on. Combinations (“systems” or “permutations”) are also available whereby the player is able to select multiple outcomes (resulting also in multiple bets).

Players may be able to extend their bet after their original predictions are successful. For example, a player having originally bet on a 5-race line, can upon their success in all five races, place an extension “Dare” bet, under the original stake for X more races, provided that the maximum allowed events limit is kept. A Variable Dare bet is also an option as described above. An indicative game sequence may be as follows according to this invention. Player first bets $10 for the next 7 races, but also selects a system of 6 events (1×7 events+7×6 events×$10=$80 stake). The expected winnings for 7 successes are×96=$960+winnings of permutation “6” ($70×48=$3,360)=$4320 Total. At the end, their 6 predictions are successful (coefficient×48). An amount of $480 is won.

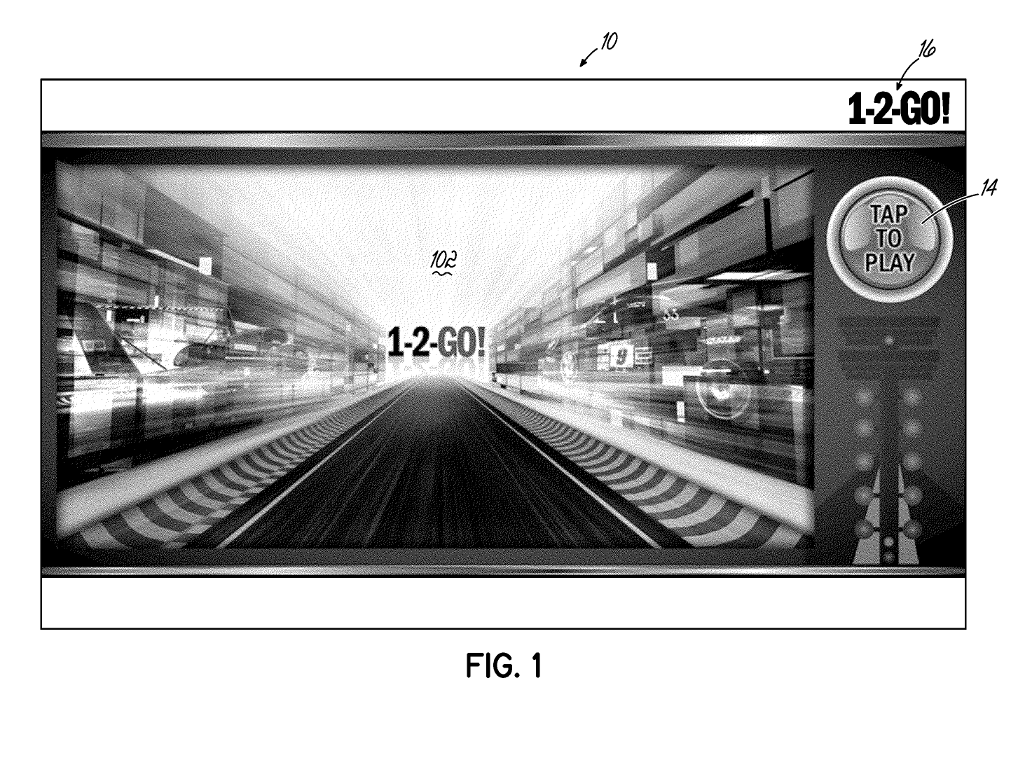

In one exemplary embodiment of this game according to an on-demand version, the game has a title 16 which may be entitled 1-2-GO! and an introductory screen 10 is shown in FIG. 1. The screen 10 shows a loop of a promotional video 12 where a “Tap-To-Play” button 14 is active. After pressing the Top-To-Play button 14, players enter a verification process as needed and according to each lottery market's rules and regulations.

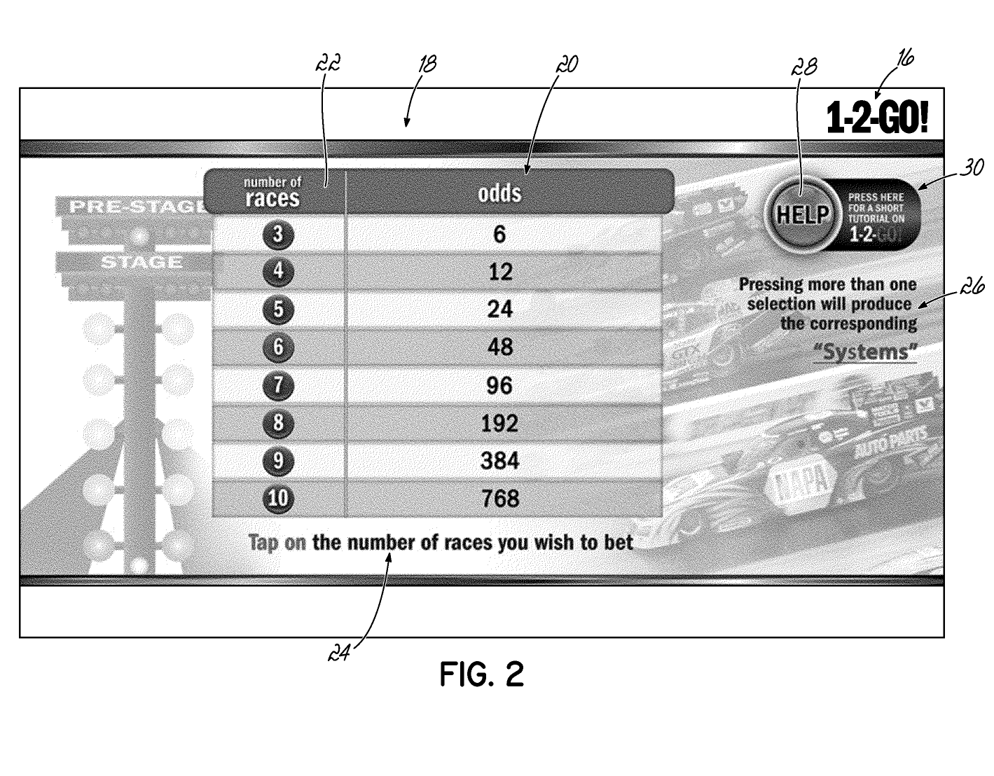

FIG. 2 shows a chart 18 with the odds per line length with a number of races column 22 on the left with an odds column 20 on the right is displayed. A message banner 24 below may guide players to select their betting line length. A message 26 “Pressing more than one selection” will produce the corresponding “Systems” allows players to learn more about the betting lines formed per number of events selected. A “Help” button 28 is available for detailed information on the game with a message “press here for a short tutorial on 1-2-Go” presented.

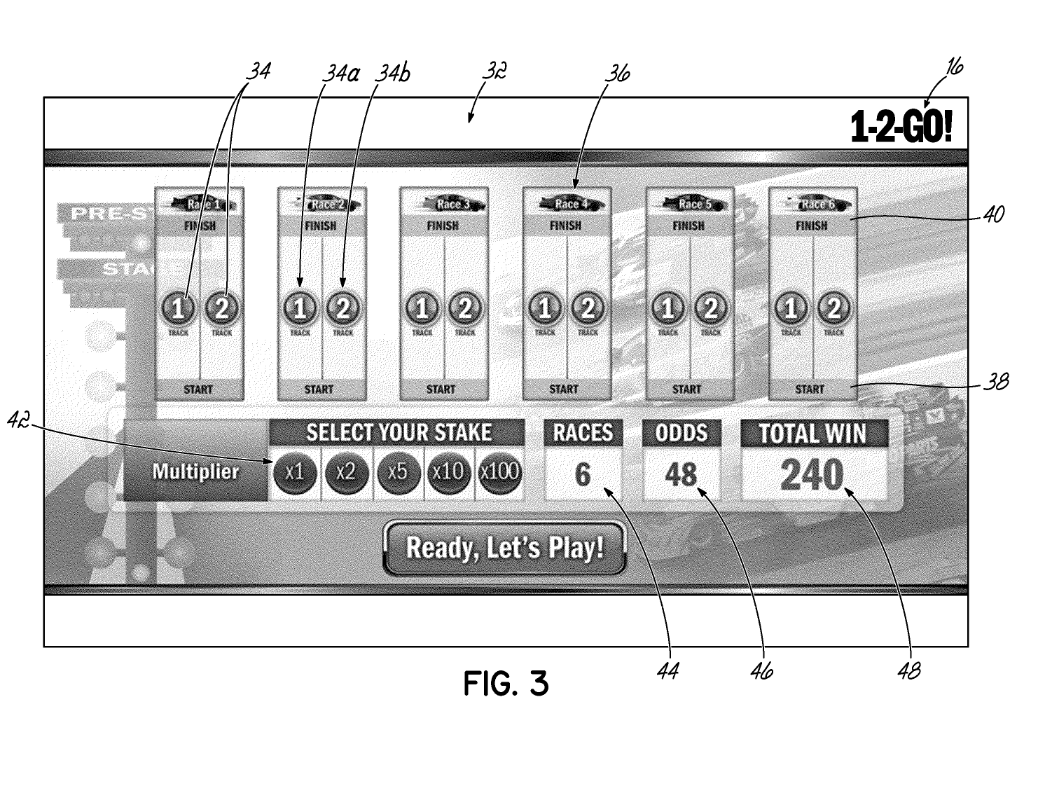

FIG. 3 shows a betting screen 32. According to the earlier player selections, the relevant number of betting or selection buttons 34 appears. For example, if players select “6”, six selections with a 1 button 34a and a 2 button 34b for each race number heading 36 may be shown. The Runner's numbers 1 and 2 appear as selection buttons proportionally to a start line 38 and a finish line 40.

A number of “Multiplier” buttons 42 with several selections (×1, ×2, ×5, ×10 ×100), may be selected to increase the stake value. The number of selected races 44, the corresponding odds coefficient 46 and the potential winnings 48 may be shown.

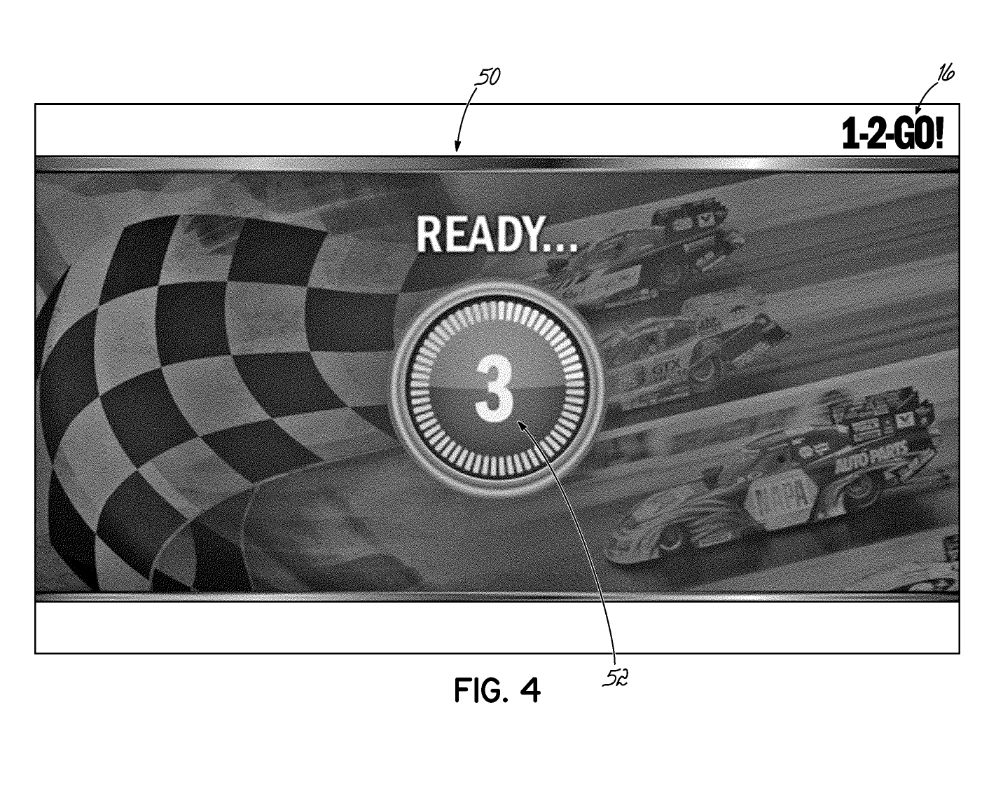

FIG. 4 is a timer screen 50. After players have made all their selections, they are shown a reverse timer 52 which counts down until the first upcoming race is shown.

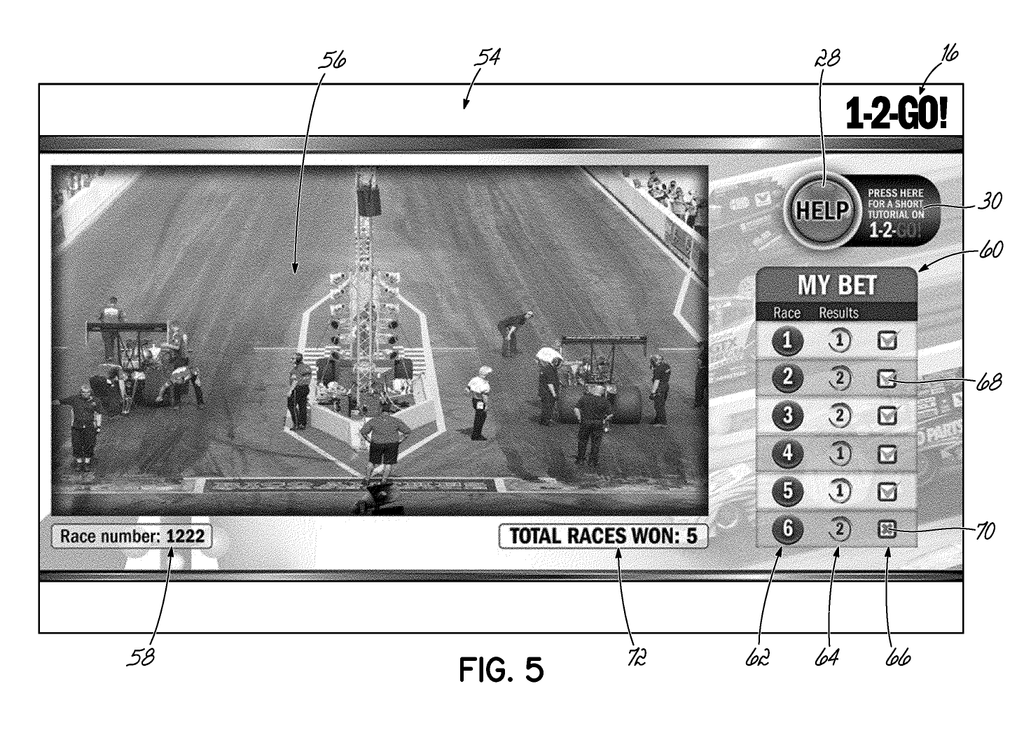

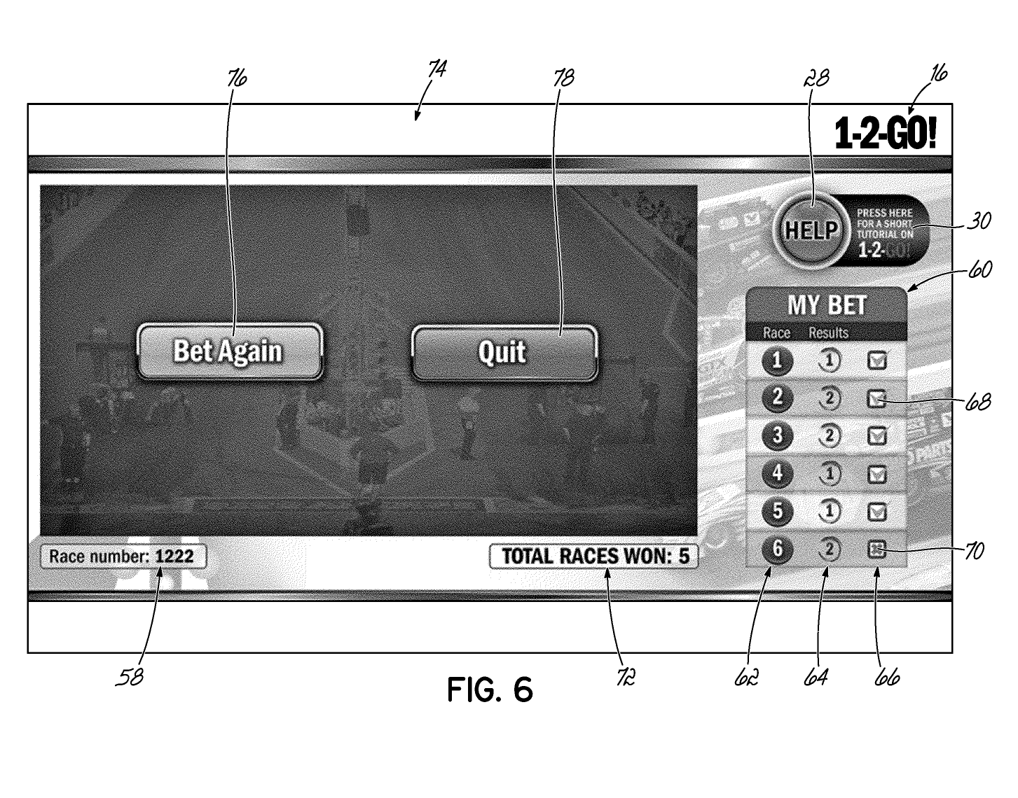

FIG. 5 shows an in-race screen 54. The race is shown on the largest part 56 of the screen. Underneath, the serial number 58 of each race appears. On the right, there is a bet chart 60 showing the race number in a first column 62, the outcome of the race in a second column and the player's successes or failures in the third column 66. After a race video is finished, the result of the race is shown in the video box. Immediately after, a mark is added next to the respective race on the bet chart 60 after each success (green check 68) or failure (red× 70) in the third column 66. Upon completion of the races required for success or upon a failed prediction, the player is informed of the final result 72 of his bet and moves to the post-race screen 74 for further options as shown in FIG. 6.

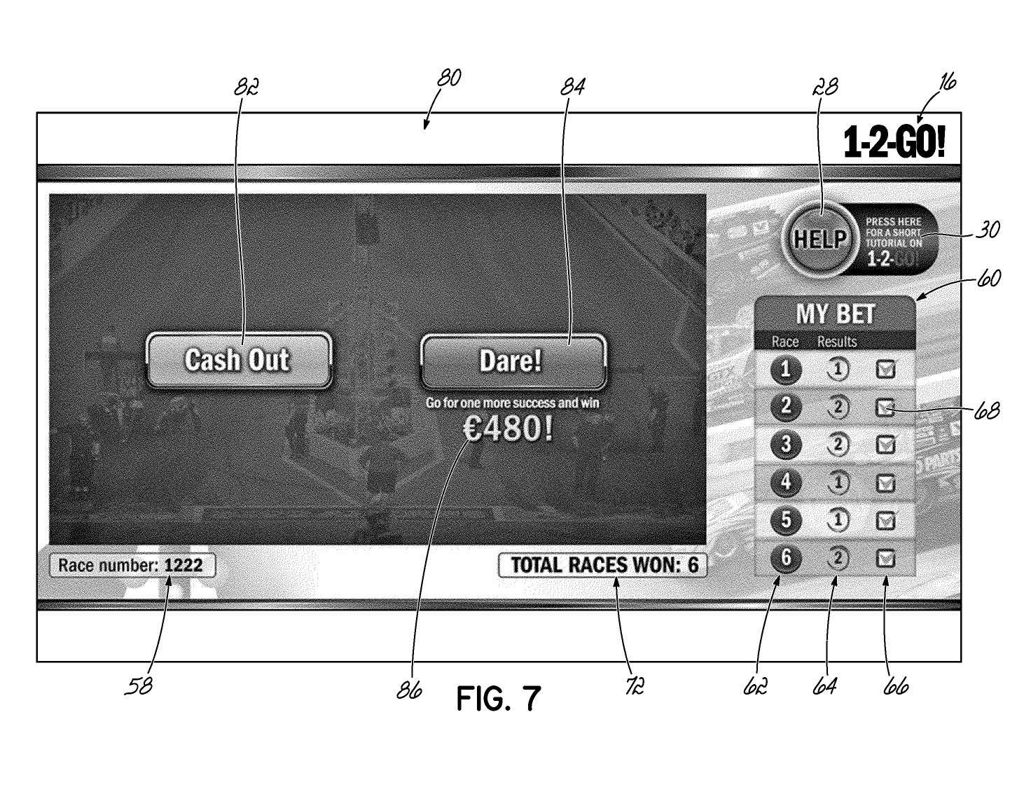

If the player lost, two options appear: a button 76 to “Bet Again” and a button 78 to “Quit”. Selection of “Bet Again” brings him back to the “Odds Screen” 18 of FIG. 2 for a new bet. If he selects “Quit”, he gets the message “Thank You for playing 1-2-Go”. As shown in FIG. 7, if the player won, he is presented with a screen having two options: a “Cash-out” button 82 to collect winnings or “Dare” button 84. Underneath the “Dare” button the actual expected winnings 86 with additional success are shown.

Upon selecting “Cash-out” 82, a “Thank You for playing 1-2-Go” message appears. Upon selecting “Dare” 84, player is directed back to the betting screen 32 of FIG. 3 for further bet selections.

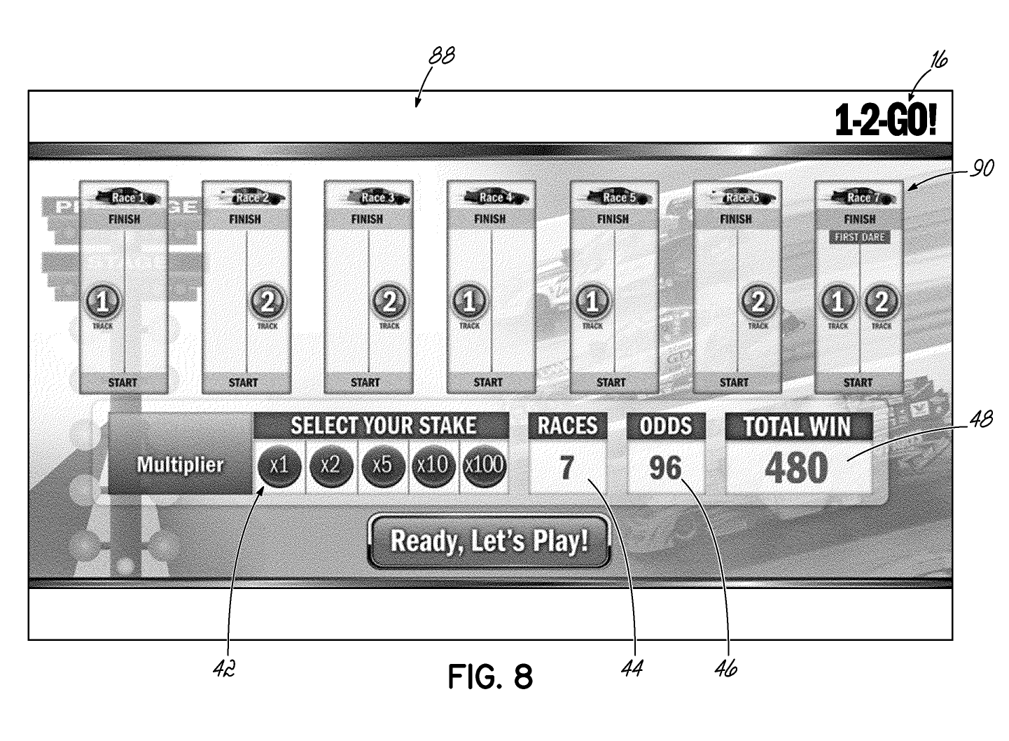

FIG. 8 shows a betting screen 88 for a “Dare” selection with the list of available additional race selections 90 and the actual potential winnings 92 based on player's original bet. The process may be repeated until the player wins and to cash-out, loses a Dare race, or ten successful predictions have been completed according to one embodiment of this invention.

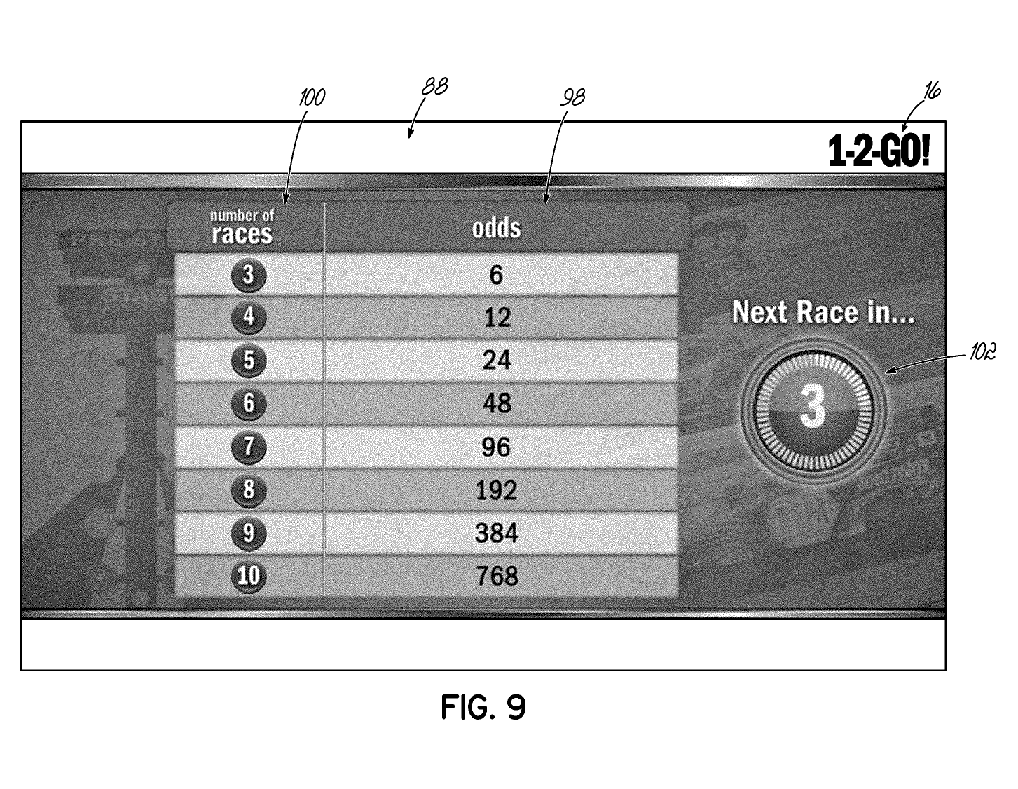

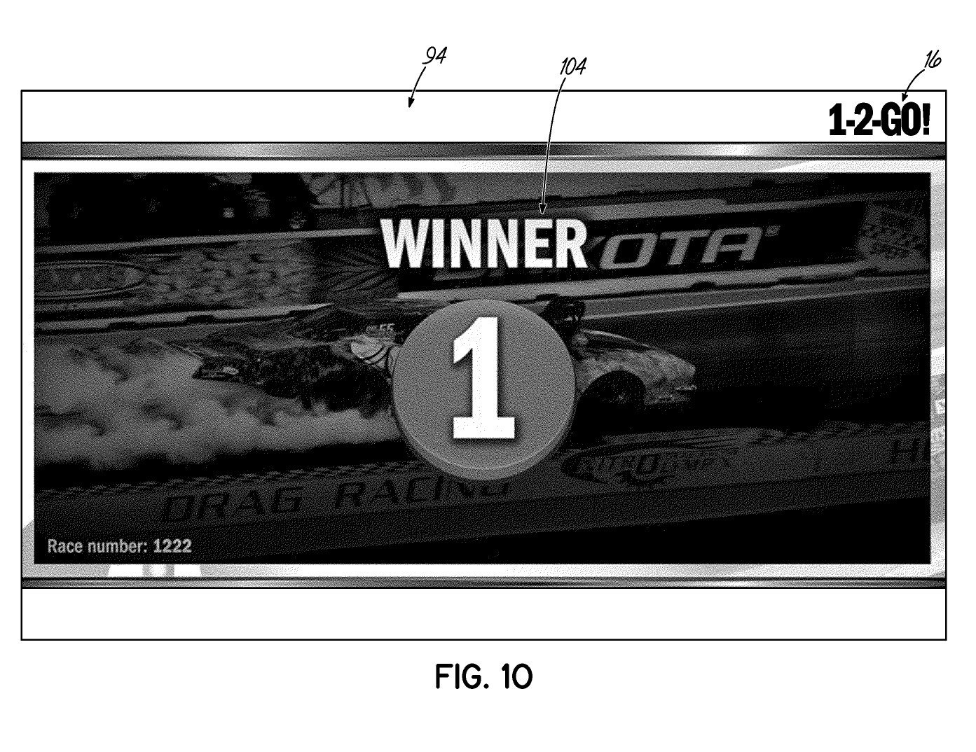

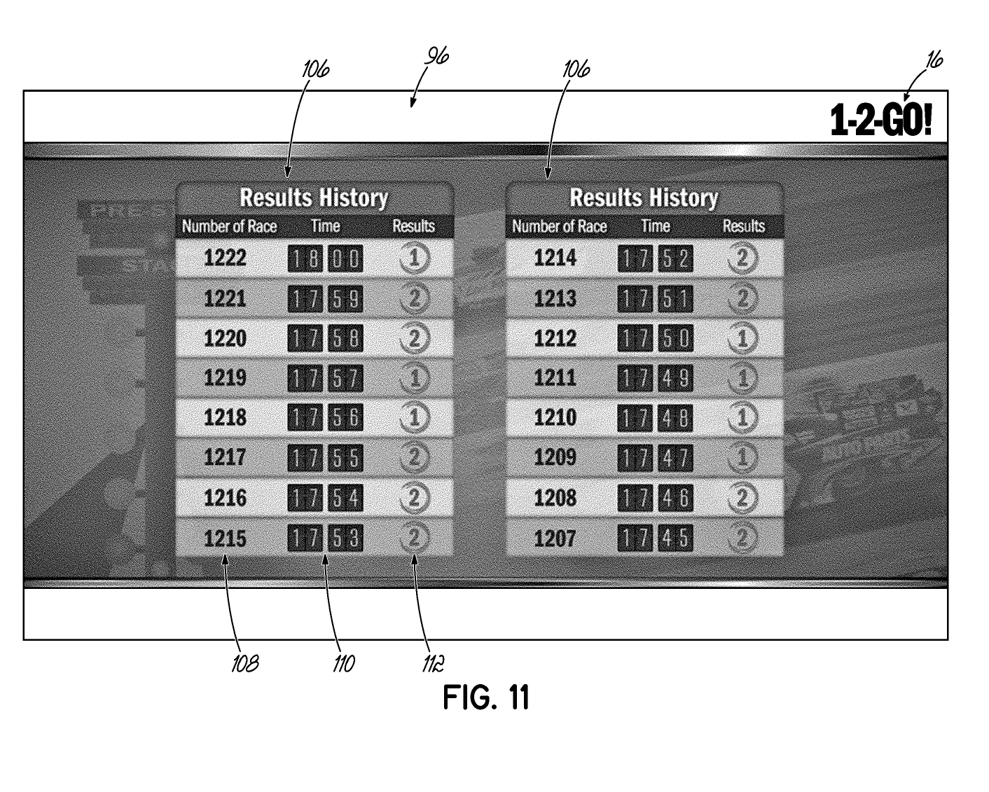

FIGS. 9-11 show various screens 92, 94, 96 for a broadcast passive version of this invention. FIG. 9 shows a pre-race screen 92 which informs players on odds 98 offered per line the quantity of racers 100. In the right section of the screen, a reverse timer 102 informs of the remaining time before the next event starts. FIG. 10 is a screen 94 which displays race videos. Immediately after the race, the result 104 is superimposed and shown for a few seconds. FIG. 11 is a post-race screen 96 with a chart on the left with the columns: “Number of Race” 108, “Time” 110 and “Results” 112. This informs players of the results history by race number, time the event was shown, and the result, respectively. The last sixteen results may be shown, with the most recent on top. The screens 92, 94, 96 of FIGS. 9-11 may be shown successively for every scheduled event.

Exemplary game architecture according to this invention may be as follows. Suitable examples of gaming devices of this invention include video lottery terminals, virtual lottery draw machines, slot machines, video poker machines, digital roulette machines, hand-held cell phones or other personal digital assistants, web sites, POS TV monitors, touch-screens and others. Conceptual principles of a system for implementing a network-based lottery game wherein players are given access to a network game site for play of a lottery game having a predetermined outcome according to various embodiments of this invention include the following. It should be understood that this invention, system and associated methods are not limited by any particular type of game, and the term “lottery game” is used herein to denote any type of probability-based game offered to eligible persons. The games may be presented to players purely for entertainment value at no cost to the player. Prizes may be awarded to a player for a winning game play, which may include a cash award. In other embodiments, the player places a wager amount for play of the lottery game in the hopes of winning a cash award or other type of prize.

The game may be administered by a lottery provider, which is the entity that provides a lottery to a gaming authority or administrator. In an alternate embodiment, the lottery provider and gaming authority may be the same entity. The gaming authority may be, for example, a state or other regional governmental entity that provides lottery games to eligible players via authorized retailers or retail establishments. In the United States, for example, the gaming authority may be a state or affiliation of states that offers lottery games to their residents via the sale of lottery games at authorized retail establishments.

The gaming authority typically utilizes a central host computer system in communication with the various retail establishments, particularly the lottery terminals maintained at the retail establishments (also referred to as point-of-sale terminals of POS terminals). Typically, a vast number of such terminals are operatively coupled to the central host computer system via any suitable communications network, which may be, for example, the internet, a wide area network (WAN), a local area network (LAN), a telephone system, and so forth. In a particular embodiment, the lottery network may include a state lottery system operating within an individual state or region of states, wherein the lottery terminals are interconnected to the game administrator and host computer directly or through an intermediary network for tracking, administration, and coordination of the state lottery system, including control of issued tickets, prizes, amounts wagered, and so forth. It should be readily appreciated that this invention encompasses any suitable communications architecture that provides the lottery player with the ability to communicate and interact with the game administrator's central host computer system.

The point-of-sale (POS) terminals or other gaming devices may include any conventional feature known to those skilled in the art related to lottery terminals. The terminal includes features and functionality to allow a player or retail clerk to enter the information required to participate in the lottery game. An exemplary terminal includes a housing, one or more input devices, which may be a control panel having input keys, a display, a value input device such as a card reader, a play slip or ticket reader, and a ticket printer. The play slip reader is typically configured to read user selection marks, bar codes, magnetically stored information, or any other desired input information. Control panel input keys allow the player or retail clerk to select the game to be played, input the value to be wagered, manually enter selected lottery characters, and input any other information necessary to play the lottery game. The terminal may include a display which may be an LCD, a CRT, or touch-screen capable of receiving and displaying information related to the game. The value input device may include any device that can accept value or a wager from a customer, such as a card reader or an optical currency collector. The value input device may be integrated with external devices, such as a cash register or other retail terminals, to exchange information necessary to receive and record the wagering transaction. The lottery ticket printer may be used to print or otherwise encode lottery tickets with information selected or required to play the lottery game. The printer may provide lottery tickets that reflect a player's selections, or complete lottery slips if the selection was generated automatically by the terminal. The lottery tickets may be printed on paper stock or electronic tickets displayed on a screen.

The host computer system may be a single networked computer, or a series of interconnected computers having access to the lottery system or network via any suitable networking system. Generally, such computer systems are configured to manage, execute, and control the individual lottery terminals and the routines used to play various lottery games, or track information related to the sale and distribution of pre-printed instant lottery tickets, such as scratch-off lottery tickets. The host computer may include memory for storing lottery programs, files, and routines, a microprocessor for executing stored routines, random access memory (RAM), and an input/output (I/O) bus. In addition, the host computer may be in communication with any manner of external device, including external databases. Such databases may provide a data repository for the storage and correlation of information gathered from the individual lottery terminals relating to the individual terminals, such as terminal specific information like the machine ID, sales establishment, location, and ticket-specific information. It should be readily appreciated that the host computer may encompass any configuration of hardware and software applications necessary to manage, execute, and control administration of the lottery game.

A game server system may be provided with any suitable hardware and software configuration for enabling play of network-based lottery games whereby players access a game site (e.g., an internet site) maintained by the game server system via a network-enabled device and communications network. The network-enabled device may be, for example, a personal computer, smart phone, personal digital assistant (PDA) tablet, or other intelligent communications device. The communication network may be, for example, the internet, a wide area network (WAN), a local area network (LAN), a telephone system, and so forth. In a particular embodiment, the game server system maintains an internet game site accessible to players via the internet.

It should be appreciated that this game system and method are not limited to an internet implementation, but encompass any system configuration wherein players are provided access to a game site via a communications network. This network may be a WAN or LAN provided, for example, solely to patrons of certain establishment, such as a casino or other type of gaming house.

A lottery ticket may be used to initiate the game. One embodiment of a ticket includes any manner of indicia that advertises, describes, illustrates, or in any way presents aspects of the particular lottery game to a purchaser. The lottery ticket may include a game component that is completely independent of the network-based game. For example, the lottery ticket may implement an instant-win game wherein players play a scratch-off game in the game area. As is well known, typical scratch-off games include game indicia and prize award indicia that are covered by a removable coating. The player removes the coating to reveal whether or not the ticket represents a win or loss. It should be appreciated that this invention is not limited by any particular type of additional game component implemented by the ticket, and that the scratch-off game described is for representative purposes only.

A game playing and viewing system according to one embodiment of this invention may include a number of components for performing specific functions. The components may include, for example, storage components for data structures for storing game variations, present game session information, game session history, and win history. A game playing and viewing system may also include components used to access the payment and payout data structures.

The game playing and viewing system according to one embodiment of this invention may also include a game engine. A game engine may perform numerous functions, including drawing winning elements for a game and displaying the drawn winning elements through any communication means, including on a lottery terminal, over the internet (e.g., through a website or internet messaging, or e-mail), or by text messaging on a cell phone. The game playing and viewing system may also receive communication from players indicating a winning game ticket. Communication may be received using any method, including over the internet (e.g., through a website, internet messaging, or e-mail) or by text messaging on a cell phone.

Acts described above and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a number of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of this invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of this invention.

It should be appreciated that any single component or collection of multiple components of a computer system, e.g., the computer system described below, that performs the functions described above can be generically considered as one or more controllers that control the above-discussed functions. The one or more controllers can be implemented in numerous ways, such as with dedicated hardware, or using a processor that is programmed using microcode or software to perform the functions recited above.

Another component of the game playing and viewing system may be a driver that streams video via a broadband, satellite, or wireless medium to a user interface. If the game is played completely automatically, the user interface may be merely a video terminal including television with no user input means. Viewing access may be controlled by standard means for conditional access including using set top box addresses, telephone numbers or internet protocol (IP) addresses.

The above is merely illustrative embodiments of a game playing and viewing system. Such illustrative embodiments are not intended to limit the scope of the invention, as any of numerous other implementations of a game playing and viewing system, for example, variations of conditional access are possible and are intended to fall within the scope of the invention. This invention is not intended to be limited to any particular implementation of a game playing and viewing system unless such claim includes a limitation explicitly reciting a particular implementation.

This invention and components thereof such as the payment, payout, and game engines, may be implemented using software (e.g., C, C#, C++, Java, or a combination thereof), hardware (e.g., one or more application-specific integrated circuits, processors or other hardware), firmware (e.g., electrically-programmed memory), or any combination thereof. One or more of the components may reside on a single system (e.g., the payment subsystem), or one or more components may reside on separate, discrete systems. Further, each component may be distributed across multiple systems, and one or more of the systems may be interconnected.

Further, on each of the one or more systems that include one or more components, each of the components may reside in one or more locations on the system. For example, different portions of the components may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

This invention may be implemented on a computer system described below. Computer system is merely an illustrative embodiment of a game system. Such an illustrative embodiment is not intended to limit the scope of the invention, as any of numerous other implementations of the game system, for example, variations of the system, are possible and are intended to fall within the scope of the invention. For example, a parallel system for viewing by interactive television may include one or more additional video streamers specific for interactive television. None of the claims set forth below are intended to be limited to any particular implementation of the game system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. Moreover, cloud based hosting may be utilized with this invention. It should be appreciated that one or more of any type computer system may be used to partially or fully automate play of the described game according to various embodiments of the invention. Further, the software design system may be located on a single computer or may be distributed among a plurality of computers attached by a communications network.

A general-purpose computer system according to one embodiment of the invention is configured to perform any of the described game functions including, but not limited to, player subscription or payment, player chosen elements or elements chosen for the player, drawing winning elements, and communicating with, verifying, and paying winners. It should be appreciated that the system may perform other functions, including network communication, and the invention is not limited to having any particular function or set of functions.

For example, various aspects of the invention may be implemented as specialized software executing in a general-purpose computer system. The computer system may include a processor connected to one or more memory devices, such as a disk drive, memory, or other device for storing data. Memory is typically used for storing programs and data during operation of the computer system. Components of computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components of system. Computer system also includes one or more input devices, for example, a keyboard, mouse, trackball, microphone, touch screen, and one or more output devices, e.g., a printing device, display screen, or speaker. In addition, computer system may contain one or more interfaces that connect computer system to a communication network in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in storage system or in memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system is disclosed by way of example as one type of computer system upon which various aspects of the invention may be practiced, it should be appreciated that aspects of the invention are not limited to being implemented on the computer system as described herein. It should be appreciated that various aspects of the invention may be practiced on one or more computers having a different architecture or components than that disclosed herein.

Computer system may be a general-purpose computer system that is programmable using a high-level computer programming language. Computer system may be also implemented using specially programmed, special purpose hardware. In computer system, the processor is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL), or interpreted (e.g., Java) code which communicate over a communication network (e.g., the internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of this invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML, or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the capabilities of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method of facilitating the play of an instant win game comprising the steps of:
providing to a player an instant win game on a play device, the instant win game including a plurality of binary game contests each of which results in either a first outcome or a second outcome;
receiving from the player a quantity selection of a first quantity of the binary game contests in which the player will participate;
establishing a player's odds of winning based on the first quantity of the binary game contests;
establishing a player's projected total win amount based on the player's odds;
receiving from the player an outcome selection of either the first outcome or the second outcome for each of the first quantity of the binary game contests;
generating an outcome for each of the first quantity of the binary game contests;
determining whether each outcome selection from the player matches the respective outcome for each of the first quantity of the binary game contests;
calculating a winning amount for the player; and
remitting to the player the winning amount.

2. The method of claim 1 further comprising:
receiving from the player a multiplier selection for the first quantity of the binary game contests.

3. The method of claim 1 further comprising, if the winning amount is greater than zero:
offering the player an additional binary game contest;
establishing a player's further odds of winning based on the first quantity and the additional binary game contests;
establishing a player's projected total win amount based on the player's further odds;
receiving from the player a selection of either the first outcome or the second outcome for the additional binary game contest;
generating an outcome for the additional binary game contest;
determining whether the selection from the player matches the outcome for the additional binary game contest;
calculating an additional winning amount for the player; and
remitting to the player the additional winning amount.

4. The method of claim 3 wherein a stake amount for the additional game is the winning amount.

5. The method of claim 3 further comprising:
soliciting from the player a stake amount for the at least one additional game, wherein the stake amount is less than the winning amount.

6. The method of claim 5 wherein the additional selection from the player for the additional game does not match the outcome of the additional game and the additional winning amount is greater than zero and less than the winning amount.

7. The method of claim 1 further comprising:
displaying a timer indicating a deadline by which the player must submit the selection of each of the first quantity of the binary game contests.

8. The method of claim 1, further comprising:
receiving a first payment from the player for the entry in the instant win game; and
applying at least a portion of the winning amount as second payment for entry in the additional binary game contest.

9. The method of claim 1, further comprising:
transmitting the quantity selection from the play device to a central computer via a network;
transmitting the outcome selections from the play device to the central computer; and
transmitting the outcome for each of the first quantity of binary game contests from the central computer to the play device.

10. The method of claim 1 wherein the generating step further comprises:
randomly determining the outcome of each binary game contest.

11. The method of claim 10 further comprising:
randomly selecting the outcome of each binary game contest from a library populated by the first outcome and the second outcome which are equally represented therein.

12. The method of claim 1 wherein each binary game contest is a race between a first and a second participant, the method further comprising:
displaying each race in the first quantity to the player on the play device.

13. A method of facilitating the play of an instant win game comprising the steps of:
providing to a player an instant win game on a play device, the instant win game including a plurality of binary game contests each of which results in either a first outcome or a second outcome;
receiving from the player a quantity selection of a first quantity of the binary game contests in which the player will participate;
receiving from the player a multiplier selection for the first quantity of the binary game contests;
establishing a player's odds of winning based on the first quantity of the binary game contests;
establishing a player's projected total win amount based on the player's odds;
receiving from the player an outcome selection of either the first outcome or the second outcome for each of the first quantity of the binary game contests;
displaying a timer indicating a deadline by which the player must submit the selection of each of the first quantity of the binary game contests;
generating a random outcome for each of the first quantity of the binary game contests;
determining whether each outcome selection from the player matches the respective outcome for each of the first quantity of the binary game contests;
calculating a winning amount for the player; and
remitting to the player the winning amount;
wherein each binary game contest is a race between a first and a second participant, the method further comprising displaying each race in the first quantity to the player on the play device.

14. The method of claim 13 further comprising, if the winning amount is greater than zero:
offering the player an additional binary game contest;
establishing a player's further odds of winning based on the first quantity and the additional binary game contests;
establishing a player's projected total win amount based on the player's further odds;
receiving from the player a selection of either the first outcome or the second outcome for the additional binary game contest;
generating an outcome for the additional binary game contest;
determining whether the selection from the player matches the outcome for the additional binary game contest;
calculating an additional winning amount for the player; and
remitting to the player the additional winning amount.

15. The method of claim 14 wherein a stake amount for the additional game is the winning amount.

16. The method of claim 14 further comprising:
soliciting from the player a stake amount for the at least one additional game, wherein the stake amount is less than the winning amount.

17. The method of claim 16 wherein the additional selection from the player for the additional game does not match the outcome of the additional game and the additional winning amount is greater than zero and less than the winning amount.

18. The method of claim 13 further comprising:
randomly selecting the outcome of each binary game contest from a library populated by the first outcome and the second outcome which are equally represented therein.

19. A non-transitory computer-readable medium having instructions stored thereon, the instructions configured to cause a processor executing the instructions to perform a method of facilitating the play of an instant win game comprising the steps of:
providing to a player an instant win game on a play device, the instant win game including a plurality of binary game contests each of which results in either a first outcome or a second outcome;
receiving from the player a quantity selection of a first quantity of the binary game contests in which the player will participate;
establishing a player's odds of winning based on the first quantity of the binary game contests;
establishing a player's projected total win amount based on the player's odds;
receiving from the player an outcome selection of either the first outcome or the second outcome for each of the first quantity of the binary game contests;
generating an outcome for each of the first quantity of the binary game contests;
determining whether each outcome selection from the player matches the respective outcome for each of the first quantity of the binary game contests;
calculating a winning amount for the player; and
remitting to the player the winning amount.

20. A system for generating a racing lottery game, comprising:
a racing lottery computing device configured to:
receive a selection of a plurality of binary game contests selected by a player,
randomly select an outcome from a first outcome or a second outcome for each of the binary games selected by the player,
determine a first plurality of races that have the first outcome and a second plurality of races that have the second outcome,
randomly select a race for each selected binary game from the first plurality of races when the selected outcome is the first outcome or from the second plurality of races when the selected outcome is the second outcome, and
stream each selected race to a player device; and
the player device configured to:
receive a selection of a plurality of binary game contests from a player,
transmit the selection of the plurality of binary game contests to the racing lottery computing device, and
broadcast each of the streamed races to the player via a display.
